(19) United States
(12) Patent Application Publication
(10) Pub. No.: US 2024/0103339 A1
(43) Pub. Date: Mar. 28, 2024

(54) CAMERA MODULE

(71) Applicant: SAMSUNG ELECTRO-MECHANICS CO., LTD., Suwon-si (KR)

(72) Inventor: Su Kyeong KIM, Suwon-si (KR)

(73) Assignee: SAMSUNG ELECTRO-MECHANICS CO., LTD., Suwon-si (KR)

(21) Appl. No.: 18/112,842

(22) Filed: Feb. 22, 2023

(30) Foreign Application Priority Data
Sep. 27, 2022 (KR) 10-2022-0122641

(51) Int. Cl. G03B 5/00; G02B 7/08; G02B 7/182; G02B 13/00; G02B 27/64

(52) U.S. Cl. CPC G03B 5/00; G02B 7/08; G02B 7/182; G02B 13/0065; G02B 27/646; G03B 2205/0023; G03B 2205/0069

(57) ABSTRACT

A camera module includes a housing having an internal space; a lens module, disposed in the internal space, including at least one lens arranged in a direction of an optical axis; an image sensor, disposed in the housing, configured to have an imaging surface oriented in a direction intersecting the direction of the optical axis; and a reflective module, tiltably disposed in the internal space, configured to reflect light passing through the lens module towards the image sensor, and rotatably tilt about an axis perpendicular to the optical axis.

### CROSS-REFERENCE TO RELATED APPLICATION(S)

This application claims the benefit under 35 USC 119(a) of Korean Patent Application No. 10-2022-0122641 filed on Sep. 27, 2022, in the Korean Intellectual Property Office, the entire disclosure of which is incorporated herein by reference for all purposes.

### BACKGROUND

### 1. Field

The present disclosure relates to a camera module.

### 2. Description of Related Art

Recently, camera modules have been adopted in portable electronic devices such as smartphones, tablet PCs, and laptops.

Portable electronic devices have tended to have a reduced thickness in accordance with market demand; accordingly, there is a desire to miniaturize camera modules used in portable electronic devices.

In order to prevent the height of a camera module from greatly affecting the thickness of a portable electronic device, a camera module including a reflective member changing the path of light has been proposed.

However, since the reflective member is configured to change the path of light, image quality may degrade based on the assembly precision of the reflective member.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing having an internal space; a lens module, disposed in the internal space, including at least one lens arranged in a direction of an optical axis; an image sensor, disposed in the housing, configured to have an imaging surface oriented in a direction intersecting the direction of the optical axis; and a reflective module, tiltably disposed in the internal space, configured to reflect light passing through the lens module towards the image sensor, and rotatably tilt about an axis perpendicular to the optical axis.

The housing may have a first space through which the optical axis passes and in which the reflective module is disposed, and a second space in which a portion of the lens module is disposed.

An optical image stabilization unit including an optical image stabilization magnet may be disposed in the reflective module and an optical image stabilization coil is disposed in the housing to oppose the optical image stabilization magnet, and the optical image stabilization unit may be configured to rotate the reflective module about the axis perpendicular to the optical axis, as the rotational axis. A focus adjustment unit including a focus adjustment magnet may be disposed in the lens module and a focus adjustment coil may be disposed in the housing to oppose the focus adjustment magnet, and the focus adjustment unit may be configured to move the lens module in the direction of the optical axis.

The focus adjustment unit may be parallelly disposed to the image sensor, and the optical image stabilization unit may be perpendicularly disposed to the image sensor.

The camera module may further include a substrate comprising: a first region, disposed in the housing, configured to oppose the imaging surface of the image sensor; a second region, extending from the first region, configured to be perpendicular to the first region; and a third region, extending from the second region, configured to be perpendicular to the first region and parallel to the second region.

The first region and the second region may be disposed on an outer surface of the housing, and the third region may be disposed on an inner surface of the housing.

The focus adjustment coil may be disposed in the first region, and the optical image stabilization coil may be disposed in the third region.

The optical image stabilization unit may further include a first optical image stabilization magnet configured to rotate the reflective module about a first axis perpendicular to the optical axis, as the rotational axis, and a first optical image stabilization coil configured to oppose the first optical image stabilization magnet; and a second optical image stabilization magnet configured to rotate the reflective module about a second axis perpendicular to the optical axis and the first axis, as the rotational axis, and a second optical image stabilization coil configured to oppose the second optical image stabilization magnet. The first and second optical image stabilization magnets may be disposed on, at least, one surface of the reflective module.

The first optical image stabilization magnet may be magnetized in the direction of the optical axis, and the second optical image stabilization magnet may be magnetized in a direction of the first axis perpendicular to the optical axis.

The lens module further may include a lens barrel on which the at least one lens is mounted, and a carrier may accommodate the lens barrel. The carrier may have an extension portion extending in the direction of the optical axis, the extension portion may be disposed in the second space.

The reflective module may include a reflective member configured to change a path of the light, and a holder on which the reflective member is mounted. A rotation plate may be further disposed between the holder and the housing.

The camera module may further include first ball members disposed between the holder and the rotation plate to be spaced apart from each other in a direction of a first axis perpendicular to the optical axis, and second ball members disposed between the rotation plate and the housing to be spaced apart from each other in a direction of a second axis perpendicular to the optical axis and the first axis.

In another general aspect, a camera module includes a housing having an internal space; a lens module disposed in the internal space and supported by the housing in a direction perpendicular to an optical axis; an image sensor, disposed in the housing, configured to have an imaging surface oriented in a direction intersecting a direction of the optical axis; and a reflective module, tiltably disposed between the lens module and the image sensor, configured to reflect incident light. The reflective module is supported by the housing in the direction of the optical axis, and the reflective module rotatably tilts about an axis perpendicular to the optical axis, as a rotational axis.

The image sensor may be disposed on another side of the housing in a direction in which the lens module is supported by the housing.

The lens module may include a magnet, the housing may include a yoke opposing the magnet in the direction perpendicular to the optical axis, and the magnet and the yoke may form attractive force in the direction perpendicular to the optical axis.

The reflective module and the housing may include magnetic bodies, respectively, and the magnetic bodies may be disposed to oppose each other in the direction of the optical axis, and form attractive force in the direction of the optical axis.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a schematic exploded perspective view of a camera module according to an example embodiment of the present disclosure and a diagram illustrating a light path.

FIG. 3 is an overall exploded perspective view of a camera module according to an example embodiment of the present disclosure.

FIG. 4 is a diagram illustrating an internal space of a housing according to an example embodiment of the present disclosure.

FIGS. 5A and 5B are diagrams illustrating a state in which a lens module and a reflective module are coupled to a housing according to an example embodiment of the present disclosure.

FIG. 6 is a diagram illustrating a state in which a substrate is mounted on a housing according to an example embodiment of the present disclosure.

FIG. 7 is a diagram illustrating a focus adjustment unit according to an example embodiment of the present disclosure.

FIG. 8 is a diagram illustrating a state in which a reflective module is coupled to a housing according to an example embodiment of the present disclosure.

FIG. 9 is a diagram illustrating an optical image stabilization unit according to an example embodiment of the present disclosure.

FIG. 10 is a diagram illustrating a first axis formed between a reflective module and a rotation plate according to an example embodiment of the present disclosure.

FIG. 11 is a diagram illustrating a second axis formed between a rotation plate and a housing according to an example embodiment of the present disclosure.

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

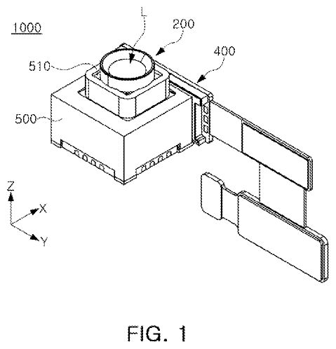

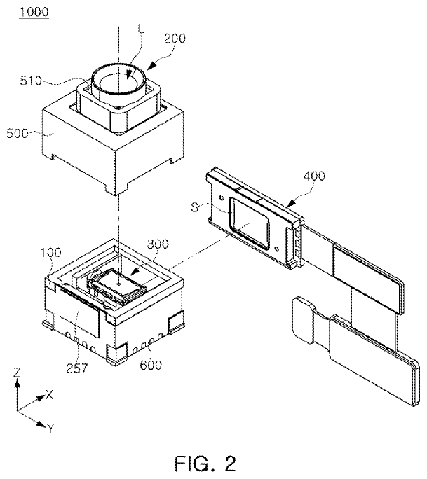

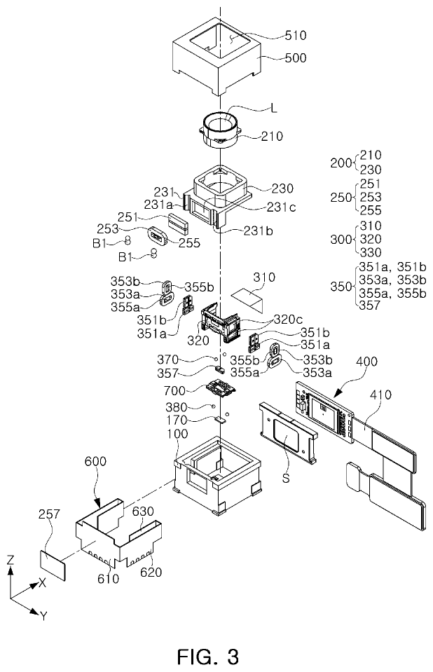

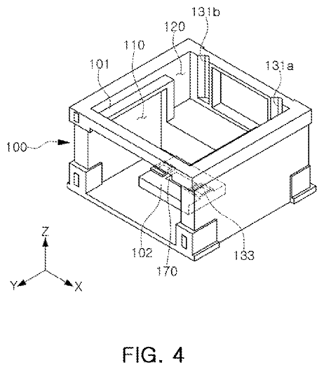

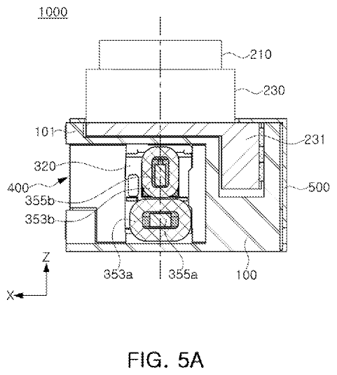

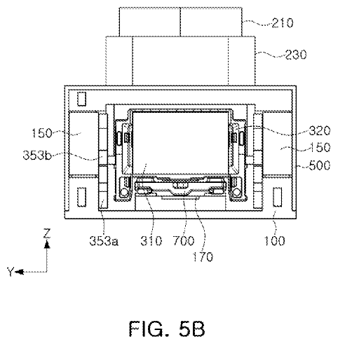

““ ”” FIG. 1 is a perspective view of a camera module according to an example embodiment of the present disclosure. FIG. 2 is a schematic exploded perspective view of a camera module according to an example embodiment of the present disclosure and a diagram illustrating a light path. FIG. 3 is an overall exploded perspective view of a camera module according to an example embodiment of the present disclosure. FIG. 4 is a diagram illustrating an internal space of a housing according to an example embodiment of the present disclosure. FIGS. 5A and 5B are diagrams illustrating a state in which a lens module and a reflective module are coupled to a housing according to an example embodiment of the present disclosure.

A camera module 1000, according to an example embodiment of the present disclosure, may include a housing 100, a lens module 200, a reflective module 300, and an image sensor module 400. In an example embodiment of the present disclosure, the lens module 200, the reflective module 300, and the image sensor module 400 may all be components disposed in the housing 100.

Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

The housing 100 may be formed of an easily moldable material. For example, the housing 100 may be formed of a plastic material.

The housing 100 may have an internal space. In an example, the housing 100 may have a quadrangular box shape with an open portion. For example, the housing 100 may have an open upper portion where two open side surfaces oppose each other among four side surfaces. In other words, the housing 100 may have a closed lower portion and two closed side surfaces opposing each other among the four side surfaces. Referring to the accompanying drawings, the housing 100 may have two open side surfaces oppose each other in a first axis direction (for example, the X-axis direction), perpendicular to an optical axis direction (for example, the Z-axis direction), among the four side surfaces, and may have two closed side surfaces opposing each other in a second axis direction (for example, the Y-axis direction), perpendicular to the optical axis direction (for example, the Z-axis direction) and the first axis direction (for example, the X-axis direction).

In an example, the lens module 200, the reflective module 300, and the image sensor module 400 may be disposed in the housing 100. In detail, the lens module 200 and the reflective module 300 may be disposed and accommodated within the internal space of the housing 100, and the image sensor module 400 may be disposed on a side surface of the housing 100. In an example, the lens module 200 and the reflective module 300 may include a focus adjustment unit 250 and an optical image stabilization unit 350, respectively. The focus adjustment unit 250 and the optical image stabilization unit 350 may be disposed in the internal space of the housing 100 and on the side surface of the housing 100, respectively.

Referring to FIG. 4, the housing 100 may have two different internal spaces, e.g., the two different internal spaces may have different heights or volumes. The housing 100 may have a first space 110 having a first height and a second space 120 having a second height different from the first height. Here, a height may refer to a distance from a bottom surface to an upper portion of the housing 110 in the optical axis direction (Z-axis direction).

Since the upper portion of the housing 100 is open, the first space 110 and the second space 120 may have different positions in the optical axis direction (Z-axis direction) of a bottom surface and, thus, may have different heights. For example, the distance (first height) from a bottom surface to an edge of an open upper portion of the first space 110 may be greater than the distance (second height) from a bottom surface to an edge of an open upper portion of the second space 120. In other words, the bottom surface of the second space 120 may be disposed at a position higher than that of the bottom surface of the first space 110 in the optical axis direction (Z-axis direction).

The first space 110 and the second space 120 may extend in the first axis direction (X-axis direction). The first space 110 and the second space 120 may have different lengths in the first axis direction (X-axis direction). For example, the length in the first axis direction (X-axis direction) of the first space 110 may be longer than the length of the second space 120 in the first axis direction (X-axis direction).

The lens module 200 and the reflective module 300 may be disposed in the first space 110. In detail, the lens barrel 210 on which one or more lenses L are mounted and a carrier 230 accommodating the lens barrel 210 may be disposed in the first space 110. Accordingly, an optical axis (Z-axis) may pass through the first space 110. In addition, the reflective module 300 may be disposed in the first space 110.

A portion of the lens module 200 may be disposed or extend into the second space 120. In detail, a portion of the carrier 230 may be disposed in the second space 120, and an extension portion 231 in which the focus adjustment unit 250 is disposed may be disposed in the second space 120.

A shield can 500 may be coupled to an upper side of the housing 100. The shield can 500 may be coupled to the upper side of the housing 100 to cover the open upper portion of the housing 100. In an example, the shield can 500 may be coupled to the upper side of the housing 100 to protect components accommodated in the internal space of the housing 100, as described above.

The shield can 500 may also have the function of shielding the components within the housing 100 from electromagnetic waves. For example, the shield can 500 may prevent electromagnetic waves generated by the camera module 1000 from affecting other electronic components of a portable electronic device or may prevent electromagnetic waves generated by the other electronic components of the portable electronic device from affecting the camera module 1000. To this end, the shield can 500 may be formed of a metallic material, such as aluminum.

The camera module 1000, according to an example embodiment of the present disclosure, may be mounted on the portable electronic device such that the shield can 500 is towards the outside of the portable electronic device. Accordingly, the shield can 500 may have an opening 510 through which light is incident. As illustrated in FIG. 1, the lens module 200 may be exposed through the opening 510, and thus light may be incident on the lens module 200.

In the camera module 1000, according to an example embodiment of the present disclosure, the lens module 200, the reflective module 300, and the image sensor module 400 may be sequentially disposed along an incident light path. That is, according to an example embodiment of the present disclosure, the reflective module 300 may be disposed between the lens module 200 and the image sensor module 400, based on the light path.

The reflective module 300 may reflect light passing through the lens module 200 before reaching the image sensor module 400. For example, the lens module 200 and the reflective module 300 may be disposed in the optical axis direction (Z-axis direction), and the reflective module 300 and the image sensor module 400 may be disposed in the first axis direction (X-axis direction). Accordingly, the reflective module 300 may change the travel path of light incident on the lens module 200 in the optical axis direction (Z-axis direction) and pass through the lens module 200 to approximately correspond to the first axis direction (X-axis direction) in which the image sensor module 400 disposed.

The camera module 1000, according to an example embodiment of the present disclosure, may include a reflective member 300 between the lens module 200 and the image sensor module 400, based on the light path. The light incident on the lens module 200 may pass through one reflective module 300 until the light reaches the image sensor module 400, such that the travel path of the light may be changed once in total.

In the camera module 1000, according to an example embodiment of the present disclosure, the travel path of the light may be changed by the reflective module 300. Therefore, when a lens having a long effective focal length (EFL) is used, the amount of protrusion of the lens may be relatively reduced.

In addition, in the camera module 1000, according to an example embodiment of the present disclosure, as the travel path of the light may be changed by the reflective module 300, the image sensor module 400 may be disposed on a side surface of the housing 100, not the bottom surface of the housing 100, thereby reducing the thickness of the camera module 1000 in the optical axis direction (Z-axis direction).

In the camera module 1000, according to an example embodiment of the present disclosure, a focus adjustment function may be implemented by moving the lens module 200, and an optical image stabilization function may be implemented by rotating the reflective module 300.

In an example, the camera module 1000 may move the lens module 200 in the optical axis direction (Z-axis direction) during focus adjustment, and may tilt the reflective module 300 at a predetermined angle about axes (X-axis and Y-axis), perpendicular to the optical axis (Z-axis), as a rotational axis during optical image stabilization. A detailed description of the focus adjustment function and optical image function of the camera module 1000 will be described below.

According to an example embodiment of the present disclosure, the lens module 200 may include the lens barrel 210 and the carrier 230. In addition, the focus adjustment unit 250 may be included as a driver driving the lens module 200.

At least one lens L capturing an image of a subject may be disposed in the lens barrel 210. The lens barrel 210 may be formed to have a hollow cylindrical shape to have an internal space, and the at least one lens L may be accommodated in the internal space. For example, one lens L may be disposed in the internal space, or a plurality of lenses L having the same or different optical properties may be disposed in the optical axis direction (Z-axis direction).

The lens barrel 210 may be accommodated in the carrier 230. The carrier 230 may have a space in which the lens barrel 210 is accommodated, and the lens barrel 210 may be coupled to the carrier 230 in a state of being accommodated in the space.

The carrier 230 may be moved in the optical axis direction (Z-axis direction) during focus adjustment. Accordingly, the lens barrel 210 coupled to the carrier 230 may also be moved together with the carrier 230 in the optical axis direction (Z-axis direction) during focus adjustment.

According to an example embodiment of the present disclosure, the carrier 230 may have an extension portion 231 extending in the optical axis direction (Z-axis direction) on one side of the carrier 230. That is, according to an example embodiment of the present disclosure, the carrier 230 may have an asymmetrical structure.

A portion of the focus adjustment unit 250 may be disposed on the extension portion 231 of the carrier 230. For example, a ball member B1 guiding movements of a focus adjustment magnet 251 and the carrier 230 in the optical axis direction (Z-axis direction) may be disposed in the extension portion 231. A description related thereto will be given below.

Referring to FIG. 5A, the carrier 230 may be disposed across the first space 110 and the second space 120. For example, a space of the carrier 230 in which the lens barrel 210 is accommodated may be disposed in the first space 110, and the extension portion 231 may be disposed in the second space 120.

The housing 100 may have a first seating portion 101 guiding a position in which the carrier 230 is aligned. The first seating portion 101 may be formed on the inner surfaces of two side surfaces opposing each other in the second axis direction (Y-axis direction). for example, the first seating portion 101 may be formed across the first space 110 and the second space 120 along the inner surfaces. The first seating portion 101 may be in the form of a guide protrusion protruding from an inner surface of the housing 100, and may be formed to have a shape corresponding to that of a portion of the carrier 230 disposed on the first seating portion 101.

The first seating portion 101 may guide the position alignment of the carrier 230 in the optical axis direction (Z-axis direction). For example, a portion of a bottom surface of the carrier 230 may be disposed on the first seating portion 101, and an interval may be formed between the carrier 230 and the reflective module 300 in the optical axis direction (Z-axis direction). Since the interval is formed between the carrier 230 and the reflective module 300 in the optical axis direction (Z-axis direction), the lens module 200 and the reflective module 300 may not interfere with each other during driving.

In addition, the first seating portion 101 may guide the position alignment of the carrier 230 in the first axis direction (X-axis direction). For example, in the carrier 230, an inner surface of the extension portion 231 may be disposed on the first seating portion 101, and an interval may be formed between the extension portion 231 of the carrier 230 and the housing 100 in the first axis direction (X-axis direction). As the inner surface of the extension portion 231 is disposed on the first seating portion 101, the carrier 230 may maintain a preset interval with the housing 100 in the first axis direction (X-axis direction). Here, the preset interval may be substantially the same as the maximum diameter of the ball member B1 disposed on the extension portion 231.

According to an example embodiment of the present disclosure, the reflective module 300 may include a reflective member 310 and a holder 320 on which the reflective member 310 is mounted. In addition, the optical image stabilization unit 350 may be included as a driver driving the reflective module 300.

The reflective member 310 may change the travel path of light. For example, the reflective member 310 may be provided as a mirror or prism reflecting light.

The reflective member 310 may be mounted on the holder 320. The holder 320 may have a space in which the reflective member 310 is mounted, and the reflective member 310 may be coupled to the holder 320 in a state of being disposed in the space.

The holder 320 may be open in a direction in which a path of light is changed by the reflective member 310. For example, the holder 320 may have an open side opposing the image sensor module 400.

A rotation plate 700 may be disposed between the reflective module 300 and the housing 100. For example, the rotation plate 700 may be disposed between the holder 320 and the housing 100.

A portion of the optical image stabilization unit 350 may be disposed in the holder 320. For example, a first ball member 370 supporting rotation of the optical image stabilization magnet 351 and the reflective module 300 may be disposed in the holder 320.

A portion of the optical image stabilization unit 350 may also be disposed on the rotation plate 700. For example, a second ball member 380 supporting rotation of the reflective module 300 may be disposed on the rotation plate 700.

As will be described below, the reflective module 300 and the rotation plate 700 may be tilted at a predetermined angle about axes (X-axis and Y-axis) perpendicular to the optical axis (Z-axis), as a rotational axis during optical image stabilization.

Referring to FIGS. 5A and 5B, the reflective module 300 may be disposed in the first space 110. For example, the reflective module 300 may be disposed on a lower portion of the lens module 200 in the first space 110, and the rotation plate 700 may be disposed on a lower portion of the reflective module 300. The lens module 200, the reflective module 300, and the rotation plate 700 may be disposed in the first space 110 in the optical axis direction (Z-axis direction).

The housing 100 may have a second seating portion 102 guiding a position in which the reflective module 300 is aligned. The second seating portion 102 may be a portion protruding from the bottom surface of the housing 100. The rotation plate 700 may be disposed on the second seating portion 102. The second seating portion 102 may be formed to at least have an area substantially equal to that of the rotation plate 700, or may be formed to have an area larger than that of the rotation plate 700. In addition, a central portion of the second seating portion 102 may substantially correspond to the optical axis (Z-axis).

According to an example embodiment of the present disclosure, the reflective module 300 may be disposed on an upper side of the rotation plate 700 in a state in which the rotation plate 700 is disposed on the second seating portion 102. That is, the second seating portion 102 may guide a position in which the reflective module 300 is aligned by guiding a position in which the rotation plate 700 is aligned.

A ball member, which may include a plurality of ball members, may be disposed between the reflective module 300 and the rotation plate 700 and between the rotation plate 700 and the housing 100, respectively. For example, a first ball member 370 spaced apart from each other in the first axis direction (X-axis direction) to form a first axis (X-axis) may be disposed between the reflective module 300 and the rotation plate 700, and second ball member 380 spaced apart from each other in the second axis direction (Y-axis direction) to form a second axis (Y-axis) may be disposed between the rotation plate 700 and the housing 100.

According to an example embodiment of the present disclosure, the image sensor module 400 may include an image sensor S, and may be disposed on the side surface of the housing 100 to intersect the optical axis (Z-axis).

According to an example embodiment of the present disclosure, the housing 100 may have four side surfaces. The housing 100 may have two open side surfaces opposing each other in the first axis direction (X-axis direction) among the four side surfaces and may have two closed side surfaces opposing each other in the second axis direction (Y-axis direction).

According to an example embodiment of the present disclosure, the image sensor module 400 may be disposed on the open side surface of the housing 100. In detail, the image sensor S may be disposed on the open side surface of the housing 100 in a state of being mounted on a sensor substrate. Accordingly, an imaging surface of the image sensor S may be disposed towards the first axis direction (X-axis direction), intersecting the optical axis (Z-axis), in a state of being disposed in the housing 100.

However, in another example embodiment, among the four side surfaces of the housing 100, two side surfaces opposing each other in the first axis direction (X-axis direction) may be closed, and two side surfaces opposing each other in the second axis direction (Y-axis direction) may be open. In this case, the positions of components disposed on the side surfaces of the housing 100, including the image sensor module 400, may be changed.

The sensor substrate may be electrically connected to a main substrate. For example, the sensor substrate may be electrically connected to the main substrate through a connection substrate 410 formed of a flexible material. Accordingly, a signal output from the image sensor S may be transmitted to the main substrate through the connection substrate 410, and the sensor substrate may receive power through the connection substrate 410. in addition, the main substrate may be connected to a connector through the connection substrate 410 to communicate with an electronic circuit outside the camera module 1000.

Referring to FIG. 3, a baffle 430 may be disposed between the image sensor S and the reflective module 300. One or more baffles 430 may be provided, and a flare phenomenon may be reduced by blocking unnecessary light from entering the image sensor S.

Next, the focus adjustment unit 250 and the optical image stabilization unit 350, according to an example embodiment of the present disclosure, will be described with reference to the drawings.

As described above, in the camera module 1000, according to an example embodiment of the present disclosure, the focus adjustment function may be implemented by moving the lens module 200, and the optical image stabilization function may be implemented by rotating the reflective module 300.

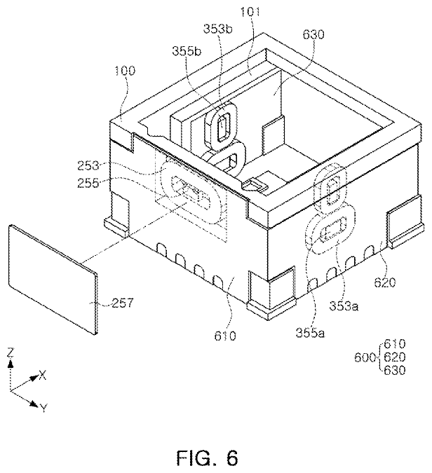

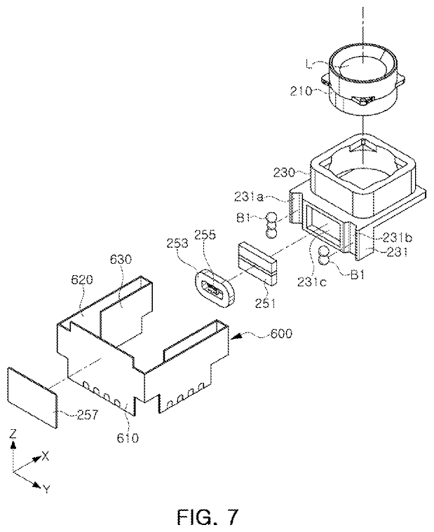

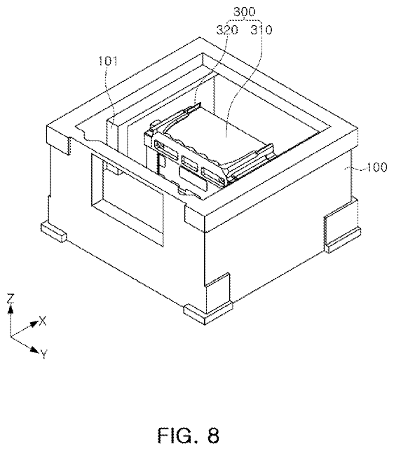

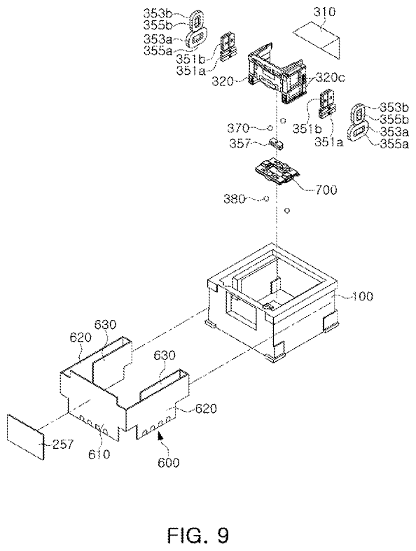

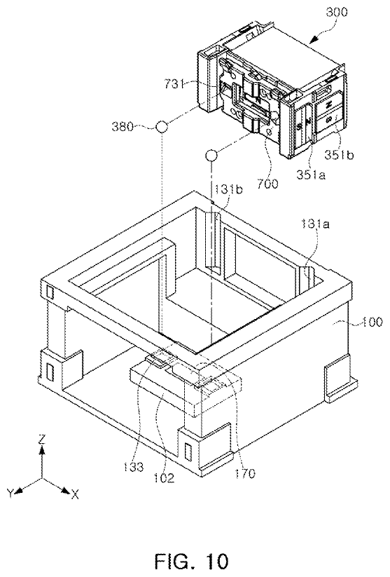

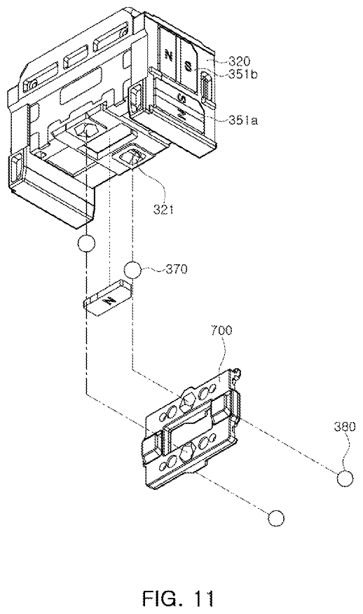

FIG. 6 is a diagram illustrating a state where a substrate is mounted on a housing according to an example embodiment of the present disclosure. FIG. 7 is a diagram illustrating a focus adjustment unit according to an example embodiment of the present disclosure. FIG. 8 is a diagram illustrating a state in which a reflective module is coupled to a housing according to an example embodiment of the present disclosure. FIG. 9 is a diagram illustrating an optical image stabilization unit according to an example embodiment of the present disclosure. FIG. 10 is a diagram illustrating a first axis formed between a reflective module and a rotation plate according to an example embodiment of the present disclosure. FIG. 11 is a diagram illustrating a second axis formed between a rotation plate and a housing according to an example embodiment of the present disclosure.

According to an example embodiment of the present disclosure, the focus adjustment unit 250 may refer to a driver moving the lens module 200 in an optical axis direction (Z-axis direction).

The focus adjustment unit 250 may generate a driving force for moving the lens module 200 in the optical axis direction (Z-axis direction), and the lens module 200 may be moved by the focus adjustment unit 250 in the optical axis direction (Z-axis direction). The lens module 200 in the optical axis direction (Z-axis direction) may be a movement relative to the housing 100.

The focus adjustment unit 250 may include a focus adjustment magnet 251 and a focus adjustment coil 253.

The focus adjustment magnet 251 may be disposed in the carrier 230 of the lens module 200. The focus adjustment magnet 251 may be disposed in the extension portion 231 of the carrier 230. The extension portion 231 of the carrier 230 may have a mounting groove 231c, and the focus adjustment magnet 251 may be disposed in the mounting groove 231c.

The focus adjustment coil 253 may be disposed in the housing 100 to oppose the focus adjustment magnet 251. in addition, the focus adjustment coil 253 may be disposed on an open side surface of the housing 100 using the substrate 600 as a medium. According to an example embodiment of the present disclosure, the focus adjustment coil 253 may be disposed on a surface of the housing 100 opposing a surface on which the image sensor S is disposed in a first axis direction (X-axis direction).

The focus adjustment coil 253 may be disposed in the housing 100 in a state of being mounted on the substrate 600. Referring to FIGS. 5A-5B, portions of the focus adjustment unit 250 and the optical image stabilization unit 350 may be mounted on the substrate 600, and the focus adjustment unit 250 and the optical image stabilization unit 350 may be disposed in the housing 100 using the substrate 600 as a medium.

According to an example embodiment of the present disclosure, the substrate 600 may be formed of a flexible material and may be disposed on three side surfaces of the housing 100. For example, the substrate 600 may be disposed on the remaining three side surfaces of the housing 100, excluding a side surface on which the image sensor S is disposed among the four sides. The substrate 600 may be disposed to cover three side surfaces of the housing 100 from the outside.

The substrate 600 may have a first region 610 disposed on a surface opposing the image sensor S. In the first region 610, a portion of the focus adjustment unit 250, including the focus adjusting coil 253, may be disposed.

The substrate 600 may have a second region 620, perpendicular to the first region 610. The second region 620 may be a portion extending from each of one side and the other side of the first region 610 in a direction, perpendicular to the first region 610. Since the second region 620 extends in a direction, perpendicular to the first region 610, the substrate 600 may be bent once in a section extending from the first region 610 to the second region 620.

The second region 620 may be disposed on a surface perpendicular to the surface on which the image sensor S is disposed. For example, the second region 620 may be disposed on two side surfaces opposing each other in a second axis direction (Y-axis direction) of the housing 100.

The substrate 600 may have a third region 630, perpendicular to the first region 610 and parallel to the second region 620. A portion of the optical image stabilization unit 350 may be disposed in the third region 630. A description related thereto will be given below.

According to an example embodiment of the present disclosure, the focus adjustment magnet 251 may be a movement member disposed in the carrier 230 and moving in the optical axis direction (Z-axis direction) together with the carrier 230, and the focus adjustment coil 253 may be a fixing member fixed to the housing 100. However, in another example embodiment, the positions of the focus adjustment magnet 251 and the focus adjustment coil 253 may be interchanged, and accordingly, the focus adjustment magnet 251 may become a fixed member and the focus adjustment coil 253 may become a movement member.

When power is applied to the focus adjustment coil 253, the carrier 230 may be moved in the optical axis direction (Z-axis direction) by electromagnetic force generated by the interaction between the focus adjustment coil 253 and the focus adjustment magnet 251. Since the lens barrel 210 is in a state of being coupled to the carrier 230, the lens barrel 210 may also be moved in the optical axis direction (Z-axis direction) as the carrier 230 is moved in the optical axis direction (Z-axis direction).

A ball member B1 guiding a movement of the carrier 230 in the optical axis direction (Z-axis direction) may be disposed in the carrier 230. According to an example embodiment of the present disclosure, the ball member B1 may be disposed in the extension portion 231 of the carrier 230, and may be disposed on opposite sides of the focus adjustment magnet 251.

In detail, the ball member B1 may be disposed between the carrier 230 and the housing 100. The carrier 230 and the housing 100 may have a guide groove in which the ball member B1 is accommodated on surfaces opposing each other, and the ball member B1 may be accommodated in the guide groove to be disposed between the carrier 230 and the housing 100.

The extension portion 231 of the carrier 230 may have a first guide groove 231a and a second guide groove 231b extending in the optical axis direction (Z-axis direction) on opposite sides of the mounting groove 231c in which the focus adjustment magnet 251 is disposed.

Referring to FIG. 7, the first guide groove 231a and the second guide groove 231b may have different cross-sectional shapes. Based on the drawing, the first guide groove 231a may function as a main guide groove, and the second guide groove 231b may function as an auxiliary guide groove.

The housing 100 may extend in the optical axis direction (Z-axis direction), and may have a third guide groove 131a and a fourth guide groove 131b opposing the first guide groove 231a and the second guide groove 231b, respectively.

The ball member B1 may be accommodated between the first guide groove 231a and the third guide groove 131a and between the second guide groove 231b and the fourth guide groove 131b, respectively, to guide the movement of the carrier 230 in the optical axis direction (Z-axis direction).

A yoke 257 may be disposed in the housing 100. The yoke 257 may be disposed in the housing 100 to oppose the focus adjustment magnet 251 with the focus adjustment coil 253 interposed therebetween. For example, the yoke 257 may be disposed on the substrate 600, and may be disposed on the other surface of the first region 610 on which the focus adjustment coil 253 is disposed.

The yoke 257 may be provided as a magnetic body, and thus attractive force may act between the yoke 257 and the focus adjustment magnet 251. For example, attractive force may act between the yoke 257 and the focus adjustment magnet 251 in a direction in which the yoke 257 and the focus adjustment magnet 251 oppose each other, that is, in the first axis direction (X-axis direction). The carrier 230 may be supported by the housing 100 in a direction in which the attractive force between the yoke 257 and the focus adjustment magnet 251 acts, that is, in the first axis direction (X-axis direction). In addition, the ball member B1 disposed between the carrier 230 and the housing 100 may maintain contact with the carrier 230 and the housing 100 by the attractive force between the yoke 257 and the focus adjustment magnet 251.

The yoke 257 may also serve to focus the magnetic force of the focus adjustment magnet 251. For example, the yoke 257 and the focus adjustment magnet 251 may form a magnetic circuit, thereby preventing magnetic flux leakage.

A first position sensor 255 may be disposed in the housing 100. The first position sensor 255 may be disposed on the open side surface of the housing 100 together with the focus adjustment coil 253 using the substrate 600 as a medium, and may oppose the focus adjustment magnet 251.

The camera module 1000, according to an example embodiment of the present disclosure, may use a closed-loop control method of detecting and feeding back a position of the lens module 200.

The first position sensor 255 may detect the position of the lens module 200. For example, the first position sensor 255 may be provided as a hall sensor.

When the camera module 1000 is powered on, an initial position of the lens module 200 may be detected by the first position sensor 255, and the lens module 200 may move from the detected initial position to an initial set position. Here, the initial position may refer to a position of the lens module 200 in the optical axis direction (Z-axis direction), and the initial set position may refer to a position in which a focal point of the lens module 200 becomes infinity. The lens module 200 may move from an initial set position to a target position by a driving signal of a circuit device providing a driving signal to the focus adjustment unit 250. In a focus adjustment process, the lens module 200 may move in opposite directions (+Z-direction and −Z-direction) on the optical axis direction (Z-axis direction).

According to an example embodiment of the present disclosure, the optical image stabilization unit 350 may refer to a driver configured to rotate the reflective module 300 about axes (X-axis and Y-axis) perpendicular to the optical axis (Z-axis), as a rotational axis. According to an example embodiment of the present disclosure, in the camera module 1000, the reflective module 300 may be tiltably coupled to the housing 100, thereby reducing the performance sensitivity of the camera module 1000 according to an assembly tolerance of the reflective member 310.

The optical image stabilization unit 350 may generate a driving force for configured to rotate the reflective module 300 about axes (X-axis and Y-axis) perpendicular to the optical axis (Z-axis), as a rotational axis. The reflective module 300 may be tilted at a predetermined angle by the optical image stabilization unit 350 about axes (X-axis and Y-axis) perpendicular to the optical axis (Z-axis), as a rotational axis.

The optical image stabilization unit 350 may include a first optical image stabilization unit 350a and a second optical image stabilization unit 350b. Hereinafter, the first optical image stabilization unit 350a may refer to a driver configured to rotate the reflective module 300 about a first axis (X-axis) perpendicular to the optical axis (Z-axis), as a rotational axis. The second optical image stabilization unit 350b may refer to a driver configured to rotate the reflective module 300 about a second axis (Y-axis) perpendicular to the optical axis (Z-axis) and the first axis (X-axis), as a rotational axis.

The optical image stabilization unit 350 may include an optical image stabilization magnet 351 and an optical image stabilization coil 353.

The optical image stabilization magnet 351 may be disposed in the holder 320 of the reflective module 300. The optical image stabilization magnet 351 may be disposed on at least one side surface of the holder 320. For example, the optical image stabilization magnet 351 may be disposed on opposite side surfaces of the holder 320. The opposite side surfaces of the holder 320 may have a mounting groove 320c, and the optical image stabilization magnet 351 may be disposed in the mounting groove 320c.

According to an example embodiment of the present disclosure, the optical image stabilization magnet 351 may include a first optical image stabilization magnet 351a and a second optical image stabilization magnet 351b. The first optical image stabilization magnet 351a and the second optical image stabilization magnet 351b may be disposed on at least one side surface of the holder 320, for example, may be disposed on opposite side surfaces of the holder 320, respectively.

The first optical image stabilization magnet 351a and the second optical image stabilization magnet 351b may be disposed on the opposite side surfaces of the holder 320, respectively. The first optical image stabilization magnet 351a and the second optical image stabilization magnet 351b may be disposed in the optical axis direction (Z-axis direction). For example, the first optical image stabilization magnet 351a may be disposed on a lower side of the second optical image stabilization magnet 351b in the optical axis direction (Z-axis direction).

The optical image stabilization coil 353 may be disposed in the housing 100 to oppose the optical image stabilization magnet 351. The optical image stabilization coil 353 may be disposed in the housing 100 using the substrate 600 as a medium. According to an example embodiment of the present disclosure, the optical image stabilization coil 353 may be disposed on a closed side surface of the housing 100. According to an example embodiment of the present disclosure, since the image sensor S and the focus adjustment coil 253 are respectively disposed on open side surfaces of the housing 100 opposing each other, the optical image stabilization coil 353 may be disposed on a surface, perpendicular to the image sensor S and the focus adjustment coil 253.

The optical image stabilization coil 353 may be disposed in the housing 100 in a state of being mounted on the substrate 600. According to an example embodiment of the present disclosure, the optical image stabilization coil 353 may be disposed on an inner surface 150 of the housing 100 in a state of being mounted on the substrate 600.

According to an example embodiment of the present disclosure, the optical image stabilization coil 353 may be disposed in the third region 630 of the substrate 600. In the third region 630, the optical image stabilization coil 353 may be included, and a portion of the optical image stabilization unit 350 may be disposed.

The substrate 600 may have a third region 630, perpendicular to the first region 610 and parallel to the second region 620. The third region 630 may be perpendicular to the first region 610 and parallel to the second region 620. The third region 630 may be a portion extending from the second region 620. The third region 630 may be formed to be parallel to the second region 620, such that the substrate 600 may be bent twice in a section extending from the second region 620 to the third region 630.

The third region 630 may be disposed on a surface, perpendicular to the surface on which the image sensor S is disposed. For example, the third region 630 may be disposed on two side surfaces opposing each other in the second axis direction (Y-axis direction) of the housing 100. That is, both the second region 620 and the third region 630 may be disposed on the two side surfaces opposing each other in the second axis direction (Y-axis direction) of the housing 100, the second region 620 may be disposed to cover the side surface of the housing 100 from the outside, and the third region 630 may be disposed on an inner side of the side surface of the housing 100. Referring to the drawing, the third region 630 may be disposed on the inner surface 150 of the housing 100.

The optical image stabilization coil 353 may include a first optical image stabilization coil 353a and a second optical image stabilization coil 353b. The first optical image stabilization coil 353a may be disposed to oppose the first optical image stabilization magnet 351a, and the second optical image stabilization coil 353b may be disposed to oppose the second optical image stabilization magnet 351b.

The first optical image stabilization coil 353a and the second optical image stabilization coil 353b may be mounted in the third region 630 of the substrate 600 to be disposed on the inner surface 150 of the housing 100. The third region 630 may oppose each of the opposite side surfaces of the holder 320.

The first optical image stabilization coil 353a and the second optical image stabilization coil 353b may be disposed in the third region 630. The first optical image stabilization coil 353a and the second optical image stabilization coil 353b may be disposed in the optical axis direction (Z-axis direction), and the first optical image stabilization coil 353a may be disposed on a lower side of the optical image stabilization coil 353b in the optical axis direction (Z-axis direction.

According to an example embodiment of the present disclosure, a surface of the first optical image stabilization magnet 351a opposing the first optical image stabilization coil 353a may be magnetized in the optical axis direction (Z-axis direction). For example, the first optical image stabilization magnet 351a may have a first polarity and a second polarity in the optical axis direction (Z-axis direction), and a neutral region may be provided between the first polarity and the second polarity. Here, the first polarity may be N-pole or S-pole, and the second polarity may be S-pole or N-pole opposite to the first polarity.

The first optical image stabilization magnet 351a and the first optical image stabilization coil 353a may generate driving force in a direction perpendicular to the second axis direction (Y-axis direction), which is a direction in which the first optical image stabilization magnet 351a and the first optical image stabilization oppose each other. The reflective module 300 may be rotated about a first axis (X-axis) as a rotational axis by driving force generated by the interaction between the first optical image stabilization magnet 351a and the first optical image stabilization coil 353a.

A surface of the second optical image stabilization magnet 351b opposing the second optical image stabilization coil 353b may be magnetized in the first axis direction (X-axis direction). For example, the second optical image stabilization magnet 351b may have a first polarity and a second polarity in the first axis direction (X-axis direction), and a neutral region may be provided between the first polarity and the second polarity. Here, the first polarity may be N-pole or S-pole, and the second polarity may be S-pole or N-pole opposite to the first polarity.

The second optical image stabilization magnet 351b and the second optical image stabilization coil 353b may generate driving force in a direction perpendicular to the second axis direction (Y-axis direction) that is a direction in which the second optical image stabilization magnet 351b and the second optical image stabilization coil 353b oppose each other. The reflective module 300 may be rotated about a second axis (Y-axis) as a rotational axis by the driving force of the second optical image stabilization magnet 351b and the second optical image stabilization coil 353b.

Referring to FIGS. 10 and 11, ball member may be disposed between the reflective module 300 and the rotation plate 700 and between the rotation plate 700 and the housing 100.

The first ball member 370 spaced apart from each other in the first axis direction (X-axis direction) may be disposed between the reflective module 300 and the rotation plate 700. The first ball member 370 may include a plurality of ball member spaced apart from each other in the first axis direction (X-axis direction).

The reflective module 300 and the rotation plate 700 may have accommodation grooves in which the first ball member 370 is accommodated on surfaces opposing each other in the optical axis direction (Z-axis direction). For example, the holder 320 of the reflective module 300 and the rotation plate 700 may respectively have a first accommodation groove 321 and a second accommodation groove 721 on the surfaces opposing each other in the optical axis direction (Z-axis direction). The first accommodation groove 321 and the second accommodation groove 721 may have a plurality of accommodation grooves spaced apart from each other in the first axis direction (X-axis direction). The first ball member 370 may be disposed between the first accommodation groove 321 and the second accommodation groove 721.

Second ball member 380 spaced apart from each other in the second axis direction (Y-axis direction) may be disposed between the rotation plate 700 and the housing 100. The second ball member 380 may include a plurality of ball members spaced apart from each other in the second axis direction (Y-axis direction).

The rotation plate 700 and the housing 100 may have accommodation grooves in which the second ball member 380 is accommodated on surfaces opposing each other in the optical axis direction (Z-axis direction). For example, the rotation plate 700 and the housing 100 may respectively have a third accommodation groove 731 and a fourth accommodation groove 133 on the surfaces opposing each other in the optical axis direction (Z-axis direction). According to an example embodiment of the present disclosure, the rotation plate 700 may be disposed on the second seating portion 102 of the housing 100, such that the fourth accommodation groove 133 may be formed on the second seating portion 102. The third accommodation groove 731, and the fourth accommodation groove 133 may have a plurality of accommodation grooves spaced apart from each other in the second axis direction (Y-axis direction). The second ball member 380 may be disposed between the third accommodation groove 731 and the fourth accommodation groove 133.

A magnetic body may be disposed in each of the housing 100 and the reflective module 300 to form an attractive force between the housing 100 and the reflective module 300. For example, a first magnetic body 170 may be disposed in the housing 100 and a second magnetic body 357 may be disposed in the holder 320 of the reflective module 300. For example, the first magnetic body 170 may be inserted into the housing 100. The rotation plate 700 disposed between the holder 320 and the housing 100 may have a through-hole such that attractive force is formed between the first magnetic body 170 and the second magnetic body 357, and the first magnetic body 170 and the second magnetic body 357 may directly oppose each other through the through-hole.

At least one of the first magnetic body 170 and the second magnetic body 357 may be a pulling magnet. For example, the first magnetic body 170 disposed in the housing 100 may be a pulling yoke, and the second magnetic body 357 disposed in the rotation holder 320 may be a pulling magnet.

For example, the first magnetic body 170 and the second magnetic body 357 may be disposed to oppose each other in the optical axis direction (Z-axis direction), and accordingly, attractive force may act between the housing 100 and the reflective module 300 in the optical axis direction (Z-axis direction). The reflective module 300 may be pulled towards a bottom surface of the housing 100, and the reflective module 300 may be supported by the housing 100 in the optical axis direction (Z-axis direction).

The first ball member 370 disposed between the reflective module 300 and the rotation plate 700 by the attractive force between the first magnetic body 170 and the second magnetic body 357, and the second ball member 380 disposed between the rotation plate 700 and the housing 100 may be stably disposed without departing from an accommodation groove.

Second and third position sensors 355a and 355b may be disposed in the housing 100. The second and third position sensors 355a and 355b may be disposed on the inner surface 150 of the housing 100 together with the optical image stabilization coil 353 using the substrate 600 as a medium. The second and third position sensors 355a and 355b may be disposed in the third region 630 and may oppose the optical image stabilization magnet 351.

The camera module 1000, according to an example embodiment of the present disclosure, may use a closed-loop control method of detecting and feeding back a position of the reflective module 300.

The second and third position sensors 355a and 355b may detect the position of the reflective module 300. For example, the second and third position sensors 355a and 355b may be provided as hall sensors.

The second position sensor 355a may be disposed to oppose the first optical image stabilization magnet 351a. The second position sensor 355a may be disposed to oppose the first optical image stabilization magnet 351a. Thus, when the reflective module 300 rotates using the first axis (X-axis) as a rotational axis, a position in the second axis direction (Y-axis direction) of the reflective module 300 may be detected.

The third position sensor 355b may be disposed to oppose the second optical image stabilization magnet 351b. The third position sensor 355b is disposed to oppose the second optical image stabilization magnet 351b. Thus, when the reflective module 300 rotates using the second axis (Y-axis) as a rotational axis, a position in the first axis direction (X-axis direction) of the reflective module 300 may be detected.

As described above, the camera module 1000, according to an example embodiment of the present disclosure, may reduce a thickness in the optical axis direction (Z-axis direction), and reduce the amount of lens protrusion. In addition, the effect of an assembly tolerance of the reflective member 310 on image quality may be minimized.

An aspect of the present disclosure provides a camera module having a thickness reduced in a direction of an optical axis, and reduce an amount of protrusion of a lens.

Another aspect of the present disclosure provides a camera module capable of minimizing image quality sensitivity according to an assembly tolerance of the reflective member.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a lens module, disposed in the internal space, including at least one lens arranged in a direction of an optical axis;
an image sensor, disposed in the housing, configured to have an imaging surface oriented in a direction intersecting the direction of the optical axis; and
a reflective module, disposed in the internal space, configured to reflect light passing through the lens module towards the image sensor, and tilt about an axis perpendicular to the optical axis, as a rotational axis.

2. The camera module of claim 1, wherein the housing has
a first space through which the optical axis passes and in which the reflective module is disposed, and
a second space in which a portion of the lens module is disposed.

3. The camera module of claim 1, wherein an optical image stabilization unit including an optical image stabilization magnet is disposed in the reflective module and an optical image stabilization coil is disposed in the housing to oppose the optical image stabilization magnet, and the optical image stabilization unit is configured to rotate the reflective module about the axis perpendicular to the optical axis, as the rotational axis, and
a focus adjustment unit including a focus adjustment magnet is disposed in the lens module, a focus adjustment coil is disposed in the housing to oppose the focus adjustment magnet, and the focus adjustment unit is configured to move the lens module in the direction of the optical axis.

4. The camera module of claim 3, wherein
the focus adjustment unit is parallelly disposed to the image sensor, and
the optical image stabilization unit is perpendicularly disposed to the image sensor.

5. The camera module of claim 3, further comprising:
a substrate comprising:
a first region, disposed in the housing, configured to oppose the imaging surface of the image sensor;
a second region, extending from the first region, configured to be perpendicular to the first region; and
a third region, extending from the second region, configured to be perpendicular to the first region and parallel to the second region.

6. The camera module of claim 5, wherein
the first region and the second region are disposed on an outer surface of the housing, and
the third region is disposed on an inner surface of the housing.

7. The camera module of claim 5, wherein
the focus adjustment coil is disposed in the first region, and
the optical image stabilization coil is disposed in the third region.

8. The camera module of claim 3, wherein
the optical image stabilization unit further includes:
a first optical image stabilization magnet configured to rotate the reflective module about a first axis perpendicular to the optical axis, as the rotational axis, and a first optical image stabilization coil configured to oppose the first optical image stabilization magnet; and
a second optical image stabilization magnet configured to rotate the reflective module about a second axis perpendicular to the optical axis and the first axis, as the rotational axis, and a second optical image stabilization coil configured to oppose the second optical image stabilization magnet,
wherein the first and second optical image stabilization magnets are disposed on, at least, one surface of the reflective module.

9. The camera module of claim 8, wherein
the first optical image stabilization magnet is magnetized in the direction of the optical axis, and
the second optical image stabilization magnet is magnetized in a direction of the first axis perpendicular to the optical axis.

10. The camera module of claim 2, wherein
the lens module further includes a lens barrel on which the at least one lens is mounted, and
a carrier accommodating the lens barrel, and
the carrier has an extension portion extending in the direction of the optical axis, the extension portion disposed in the second space.

11. The camera module of claim 2, wherein
the reflective module includes
a reflective member configured to change a path of the light, and
a holder on which the reflective member is mounted, and
wherein a rotation plate is further disposed between the holder and the housing.

12. The camera module of claim 11, further comprising:
first ball members disposed between the holder and the rotation plate to be spaced apart from each other in a direction of a first axis perpendicular to the optical axis; and
second ball members disposed between the rotation plate and the housing to be spaced apart from each other in a direction of a second axis perpendicular to the optical axis and the first axis.

13. A camera module comprising:
a housing having an internal space;
a lens module disposed in the internal space and supported by the housing in a direction perpendicular to an optical axis;
an image sensor, disposed in the housing, configured to have an imaging surface oriented in a direction intersecting a direction of the optical axis; and
a reflective module, disposed between the lens module and the image sensor, configured to reflect incident light,
wherein the reflective module is supported by the housing in the direction of the optical axis, and
the reflective module tilts about an axis perpendicular to the optical axis, as a rotational axis.

14. The camera module of claim 13, wherein the image sensor is disposed on another side of the housing in a direction in which the lens module is supported by the housing.

15. The camera module of claim 13, wherein
the lens module includes a magnet,
the housing includes a yoke opposing the magnet in the direction perpendicular to the optical axis, and
the magnet and the yoke form attractive force in the direction perpendicular to the optical axis.

16. The camera module of claim 13, wherein
the reflective module and the housing include magnetic bodies, respectively, and
the magnetic bodies are disposed to oppose each other in the direction of the optical axis, and form attractive force in the direction of the optical axis.
